(19) United States
(12) Patent Application Publication
(10) Pub. No.: US 2012/0179296 A1
(43) Pub. Date: Jul. 12, 2012

(54) APPARATUS AND METHOD FOR GENERATING MANAGEMENT PLAN OF BUILDING

(75) Inventors: Jinsoo HAN, Daejeon (KR); Chang-Sic CHOI, Daejeon (KR); Wan Ki PARK, Daejeon (KR); Youn Kwae JEONG, Daejeon (KR); IL Woo LEE, Daejeon (KR)

(73) Assignee: Electronics and Telecommunications Research Institute, Daejeon (KR)

(21) Appl. No.: 13/345,131

(22) Filed: Jan. 6, 2012

(30) Foreign Application Priority Data
Jan. 7, 2011 (KR) 10-2011-0001847

(51) Int. Cl. G06F 1/26; G06N 5/04; G06F 15/18; G05B 15/02

(52) U.S. Cl. 700/275; 706/12

(57) ABSTRACT

An apparatus for generating a management plan of a building includes a basic reference input part for receiving at least one of an indoor-outdoor environment information, a building status information, a requirement for building-management, a sensor information, and a metering information. Further, the apparatus for generating the management plan of the building includes a building-management information part for accumulatively storing past building-management data; and a rule set part which is constructed by accumulating building-management plans extracted from accumulated past building-management information. Furthermore, the apparatus for generating the management plan of the building includes a building-energy characteristic information part for storing energy-consumption characteristics shown through building-management; and an inference engine part for generating a building-management plan based on at least one of the building-management information, the rule set, and the building-energy characteristic information, in accordance with information from the basic reference input part.

### CROSS-REFERENCE TO RELATED APPLICATION(S)

The present invention claims priority of Korean Patent Application No. 10-2011-0001847, filed on Jan. 7, 2011, which is incorporated herein by reference.

### FIELD OF THE INVENTION

The present invention relates to an apparatus and a method for generating a management plan of a building; and, more particularly, to an apparatus and a method for generating a management plan of a building, which are preferable to automatically generating an optimal management plan of a building for maintaining a nice indoor environment of the building using a heater, an air conditioner, a lighting installation and a power installation, and the like, while minimizing consumption of energy.

### BACKGROUND OF THE INVENTION

Generally, a building has a heater, an air conditioner, a lighting installation, and a power installation, and the like, and is managed to maintain a nice and pleasant indoor environment (e.g., temperature, humidity, and air quality, and the like) periodically and seasonally. In this scheme, a building-manager, who controls various building-installations, stays in a building to maintain comfortableness of indoor space of the building, in which residents stay. Generally, the building-manager manages the building based on past management experience and status of the building.

However, there may be drawbacks that the conventional schemes for managing the building cannot actively prevent energy-wasting elements, because the conventional scheme is just based on the past experience of the building manager. That is, even though the building manager is experienced, it is difficult for a building manager to find the optimal building management plan considering all indoor-outdoor environment information and various conditions.

### SUMMARY OF THE INVENTION

In view of the above, the present invention provides an apparatus and a method for generating a management plan of a building, which are preferable to automatically generating an optimal management plan of a building for maintaining a nice indoor environment of the building using a heater, an air conditioner, a lighting installation and a power installation, and the like, while minimizing consumption of energy.

Further, the present invention provides an apparatus and a method for generating a management plan of a building, wherein the apparatus constructs a set of building-management plans as a rule set part by constructing a database of past building-management plans, receives indoor-outdoor environment information of the moment when an optimal building-management plan is needed, searches a nearest management plan in the rule set database through an inference engine, and provides an optimal building-management plan, which is the best plan, to the building-manager.

In accordance with a first aspect of the present invention, there is provided an apparatus for generating a management plan of a building, including: a basic reference input part for receiving at least one of an indoor-outdoor environment information, a building status information, a requirement for building-management, a sensor information, and a metering information; a building-management information part for accumulatively storing past building-management data; a rule set part which is constructed by accumulating building-management plans extracted from accumulated past building-management information; a building-energy characteristic information part for storing energy-consumption characteristics shown through building-management; and an inference engine part for generating a building-management plan based on at least one of the building-management information, the rule set, and the building-energy characteristic information, in accordance with information from the basic reference input part.

In accordance with a second aspect of the present invention, there is provided a method for generating a building-management plan of a building, including: receiving at least one of an indoor-outdoor environment information, a building status information, a requirement for building-management, a sensor information, and a metering information as a basic reference information; performing accumulation of building-management information to accumulatively store past building-management data; constructing a rule set part by accumulating building-management plans extracted from accumulated past building-management informations; constructing a building-energy characteristic information by accumulatively storing energy-consumption characteristics shown through building-management; and generating a building-management plan based on at least one of the building-management information, the rule set, and the building-energy characteristic information, in accordance with information from the basic reference input part.

In accordance with embodiments of the present invention, it is possible to manage the building more efficiently and more accurately, by constructing a rule set part using accumulated past building-management plans, and finding an optimal building-management plan nearest to input conditions through an inference engine, based on input information such as indoor-outdoor environment information, building-status information, user requirements, and sensor/metering information.

Therefore, it is possible to manage the building more stably compared to conventional management schemes based on past experiences of a building manager, since an optimal management plan is systematically generated based on past management plans accumulated for many years.

### BRIEF DESCRIPTION OF THE DRAWINGS

The objects and features of the present invention will become apparent from the following description of embodiments, given in conjunction with the accompanying drawings, in which:

FIG. 1 is a block diagram showing a structure of a building-management plan inference apparatus in accordance with an embodiment of the present invention;

FIG. 2 is a block diagram showing structure of a building-management plan inference apparatus including a building-energy simulation in accordance with an embodiment of the present invention; and

FIG. 3 is a flow chart showing an operation of a building-management plan inference apparatus in accordance with an embodiment of the present invention.

### DETAILED DESCRIPTION OF THE EMBODIMENTS

Embodiments of the present invention will be described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory usable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram. Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, embodiments of the present invention will be described with reference to the accompanying drawings which form a part hereof.

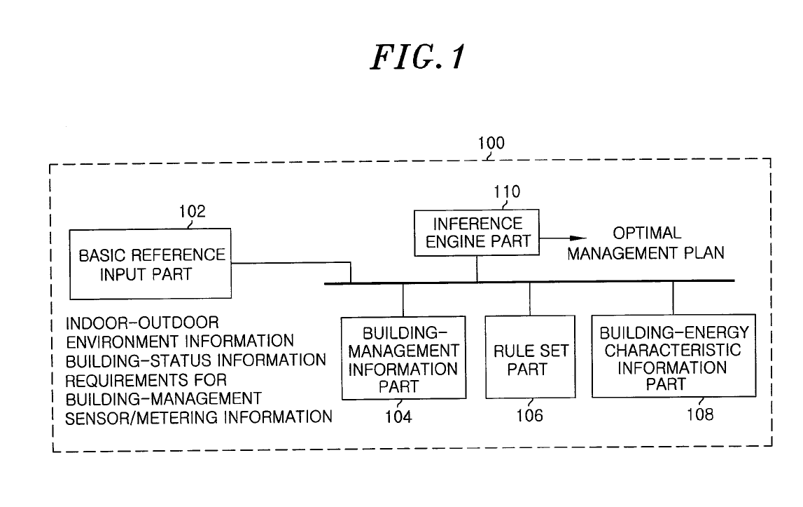

FIG. 1 is a block diagram showing a structure of a building-management plan inference apparatus in accordance with an embodiment of the present invention.

Referring to FIG. 1, a building-management plan inference apparatus 100 includes a basic reference input part 102, a building management information part 104, a rule set part 106, a building-energy characteristic information part 108, and inference engine 110.

The basic reference input part 102 collects or is received indoor-outdoor environment information, building status information, user requirements, sensor information, and metering information, and the like, and deliver the collected or received information to the inference engine part 110.

The building-management information part 104 includes a database of building-management information which is an accumulated past building-management plans of many years. Such accumulated building-management information is constructed to be a rule set, which is utilizable by the inference part 110.

The rule set part 106 can be constructed by two schemes. First, a building manager may input data for himself. Or, rules can be extracted with a predetermined standard by using an automatic system.

The rule set part 106 is an aggregation of accumulated past building-management plans of many years as rules. Generally, a building-manager determined a building-management plan by considering indoor-outdoor environment information, user requirements, and sensor/metering information and the like.

As a result of implementation of each building-management plan, amount of building-energy consumption or comfortableness of a building can be comprehended. Based on such results, a building manager can generate a new building-management plan, which can save more energy.

If such process is accumulated for many years, an optimal building-management plan can be determined more accurately under the conditions of indoor-outdoor environment information, user requirements, and sensor/metering information and the like. Then, such building-management plans accumulated for many years are defined as rules and are stored in the rule set part 106, which forms a set of building-management plans applicable to future building-managements.

When processing and accumulating the past building-management information to the rule set part 106, a building-manager may input to the rule set part 106 for himself, or an automatic system such as data-mining scheme may update rule set part 106 periodically.

The rule set part 106 is updated by adding a new building-management information, or corrected by a building-manager or a building-management plan inference apparatus when a fine-tuning for existing rules is required. As building-management rules are accumulated, if an existing building-management plan is determined to be less efficient than a predetermined standard (based on energy consumption or comfortableness of the building, and the like), the existing building-management plan can be deleted from the rule set part 106.

The building-energy characteristic information part 108 is a database, which is accumulatively storable of building-energy consumption information.

The inference engine part 110 generates an optimal building-management plan, according to which a building-energy consumption can be minimum and a comfortableness of the building is optimal, based on the rule set part 106, the building-management information part 104, and building-energy characteristic information part 108, according to input conditions such as indoor-outdoor environment information, user requirements, and sensor/metering information and the like. Through this scheme, the building-energy consumption can be minimized by eliminating energy-wasting elements while maintaining a predetermined comfortableness (i.e., temperature, humidity, and quality of air). In other words, the inference engine part 110 generates a building-management plan, which has a higher comfortableness than a predetermined standard and a lower building-energy consumption than the predetermined standard, as an optimal building-management plan.

Here, the predetermined standard may be at least one of a certain status, a rule information, a condition or a proposition of the building comfortableness and the building-energy consumption.

Through this, a building-manager can achieve an optimal building-management by having the building be managed based on the outputted optimal building-management plan. Here, the rule set part 106 can be continuously accumulated, deleted, or corrected according to new know-how's and new environments.

A building-energy consumption information, which is drawn from a building-management based on the outputted optimal building-management plan, is accumulated in the building-energy characteristic information part 108.

Meanwhile, FIG. 1 introduces a scheme, in which the optimal building-management plan is generated by the inference engine part 110. Here, the inference engine part 110 may generate only one optimal building-management plan or a plurality of optimal building-management plans. If the optimal building-management plan are more than one, then the building-manager have to select one optimal building-management plan among a plurality of generated optimal building-management plans.

Of course, one of a plurality of generated optimal building-management plans can increase efficiency of the building-management. However, if the best building-management plan among the plurality of generated optimal building-management plans is selected, efficiency of the building-management can be more increased.

Here, if a plan which can decrease energy consumption most is selected among generated optimal building-management plans, cost for energy-consumption of the building can be more saved.

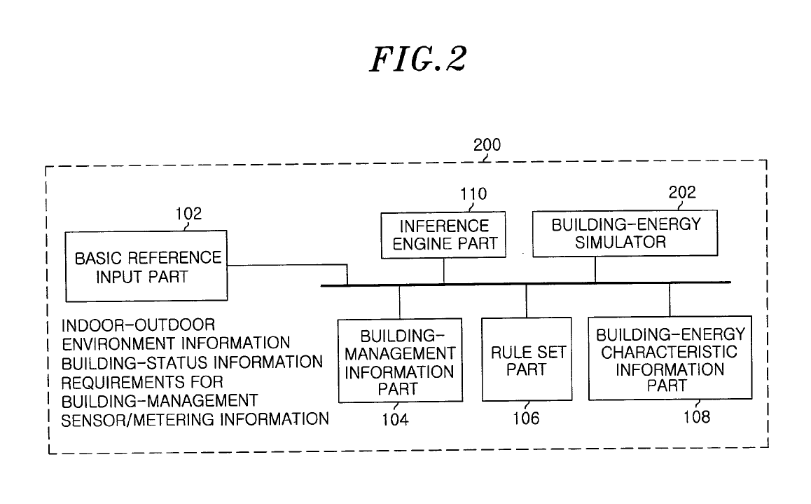

FIG. 2 is a block diagram showing structure of a building-management plan inference apparatus including a building-energy simulation in accordance with an embodiment of the present invention.

Referring to FIG. 2, a building-management plan inference apparatus 200 includes a basic reference input part 102, a building management information part 104, a rule set part 106, a building-energy characteristic information part 108, and inference engine part 110, and further includes a building-energy simulator 202.

When the inference engine part 110 provides one building-management plan, then the building-energy simulator 202 shows an estimated energy consumption under the generated building-management plan, so that the building-manager can predict energy-consumption of the building.

When the inference engine part 110 provides a plurality of building-management plans, then the building-energy simulator 202 compares each energy consumption under the each building-management plan, to select a building-management plan consuming minimum energy.

Further, building-energy characteristics can be comprehended through the building-energy simulator 202. The comprehended building-energy characteristics can be accumulated in the building-energy characteristic information part 108, and energy-consumption information under the selected optimal building-management plan can also be accumulated in the building-energy characteristic information part 108.

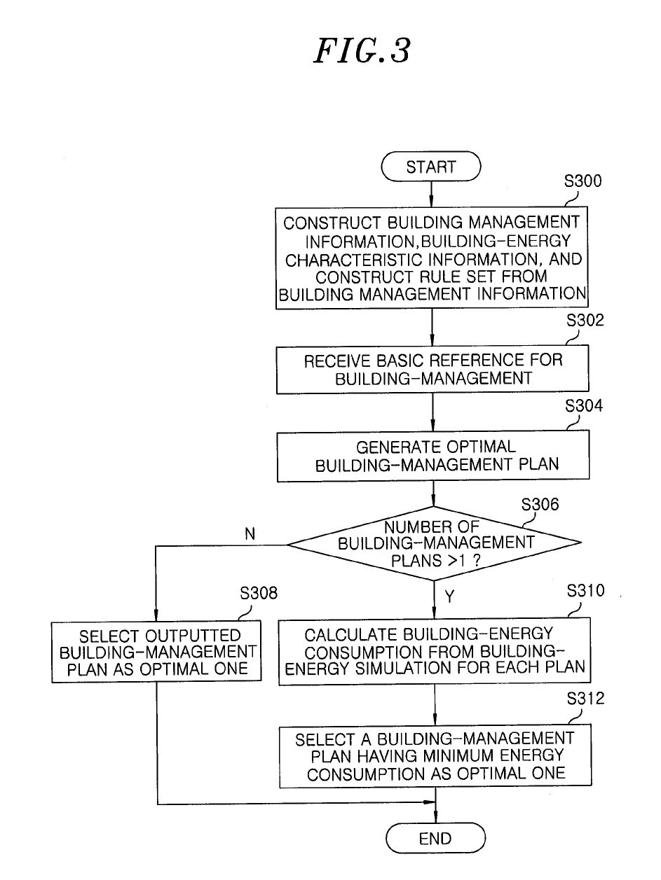

FIG. 3 is a flow chart showing an operation of a building-management plan inference apparatus in accordance with an embodiment of the present invention.

Referring to FIG. 3, in step S300, a rule is extracted from the building-management information part 104 to construct a rule set part 106. In step S302, basic reference input part 102 receives indoor-outdoor environment information, building status information, user requirements, sensor information, and metering information and the like and delivers same to the inference engine part 110.

In step S304, the inference engine part 110 generates an optimal building-management plan, based on the rule set part 106, the building-management information part 104, and building-energy characteristic information part 108, according to input conditions such as indoor-outdoor environment information, user requirements, and sensor/metering information and the like.

In step S306, when the generated building-management plan is only one, then proceeding to step 308, the generated building-management plan is selected as the optimal building-management plan, and the building is managed based on the selected optimal building-management plan.

Here, when the generated building-management plan is delivered to the building-energy simulator 202, energy-consumption of the building-management plan is comprehended.

However, when the number of the generated building-management plans is plurality, then proceeding to step 310, the generated building-management plans are delivered to the building-energy simulator 202, and the building-energy simulator 202 simulates the energy-consumption of each generated building-management plan.

In step S312, building-management plan which has minimum energy-consumption is selected as the optimal building-management plan.

The building-energy simulator 202 comprehends the energy-consumption of each building-management plan and building-energy characteristics. The building-energy characteristics are accumulated as building-energy characteristic information, returning to step 300.

As described above, in accordance with an embodiment of the present invention, there is provided an apparatus and a method for generating a management plan of a building, which are preferable to automatically generating an optimal management plan of a building for maintaining a nice indoor environment of the building using a heater, an air conditioner, a lighting installation and a power installation, and the like, while minimizing consumption of energy.

Further, in accordance with an embodiment of the present invention, there is provided an apparatus and a method for generating a management plan of a building, wherein the apparatus constructs a set of building-management plans as a rule set part by constructing a database of past building-management plans, receives indoor-outdoor environment information of the moment when an optimal building-management plan is needed, searches a nearest management plan in the rule set database through an inference engine part, and provides an optimal building-management plan, which is the best plan, to the building-manager.

While the invention has been shown and described with respect to the embodiments, it will be understood by those skilled in the art that various changes and modification may be made without departing from the scope of the invention as defined in the following claims.

What is claimed is:

1. An apparatus for generating a management plan of a building, comprising:
a basic reference input part for receiving at least one of an indoor-outdoor environment information, a building status information, a requirement for building-management, a sensor information, and a metering information;
a building-management information part for accumulatively storing past building-management data;
a rule set part which is constructed by accumulating building-management plans extracted from accumulated past building-management information;
a building-energy characteristic information part for storing energy-consumption characteristics shown through building-management; and
an inference engine part for generating a building-management plan based on at least one of the building-management information, the rule set, and the building-energy characteristic information, in accordance with information from the basic reference input part.

2. The apparatus of claim 1, wherein the inference engine part generates at least one building-management plan by comparing a comfortableness and an energy-consumption of the at least one building-management plan with predetermined standards for comfortableness and energy-consumption.

3. The apparatus of claim 1, wherein the rule set part is updated by adding a new building-management information when receiving the new building-management information, or corrected when a fine-tuning for existing rules is required.

4. The apparatus of claim 1, wherein, as building-management rules are accumulated, when an efficiency of an existing building-management rule is determined to be less than a predetermined standard, the existing building-management rule is deleted from the rule set.

5. The apparatus of claim 4, wherein the efficiency is an energy consumption or a comfortableness of the building.

6. The apparatus of claim 1, further comprising a building-energy simulator for calculating a building-energy consumption through a simulation to which the building-management plan is applied, when a number of the outputted build-management plan is one.

7. The apparatus of claim 1, further comprising a building-energy simulator for selecting a building-management plan of which comfortableness is higher than a predetermined value and building-energy consumption is lower than a predetermined standard, by simulating energy consumption of each outputted building-management plan, in case of a number of the outputted building management plans is larger than or equal to two.

8. The apparatus of claim 6, wherein the building-energy characteristic information is formed by accumulating information on the building-energy consumption outputted by the building-energy simulator.

9. A method for generating a building-management plan of a building, comprising:
receiving at least one of an indoor-outdoor environment information, a building status information, a requirement for building-management, a sensor information, and a metering information as a basic reference information;
performing accumulation of building-management information to accumulatively store past building-management data;
constructing a rule set part by accumulating building-management plans extracted from accumulated past building-management informations;
constructing a building-energy characteristic information by accumulatively storing energy-consumption characteristics shown through the building-management; and
generating a building-management plan based on at least one of the building-management information, the rule set, and the building-energy characteristic information, in accordance with information from the basic reference input part.

10. The method of claim 9, wherein said generating a building-management plan is performed such that at least one building-management plan is generated by comparing a comfortableness and an energy-consumption of the at least one building-management plan with predetermined standards for comfortableness and energy-consumption.

11. The method of claim 9, wherein the rule set part is updated by adding a new building-management information when receiving the new building-management information, or corrected when a fine-tuning for existing rules is required.

12. The method of claim 9, wherein, as building-management rules are accumulated, when an efficiency of an existing building-management rule is determined to be less than a predetermined standard, the existing building-management rule is deleted from the rule set.

13. The method of claim 12, wherein the efficiency is an energy consumption or a comfortableness of the building.

14. The method of claim 9, further comprising calculating a building-energy consumption through a simulation to which the building-management plan is applied, when a number of the outputted build-management plan is one.

15. The method of claim 9, further comprising selecting a building-management plan of which comfortableness is higher than a predetermined value and building-energy consumption is lower than a predetermined standard, by simulating energy consumption of each outputted building-management plan, in case of a number of the outputted building0management plans is larger than or equal to two.

16. The method of claim 14, wherein the building-energy characteristic information is formed by accumulating information on the building-energy consumption outputted by the building-energy simulator.
